(19) United States
(12) Patent Application Publication
(10) Pub. No.: US 2009/0326089 A1
(43) Pub. Date: Dec. 31, 2009

(54) PROCESS FOR LOWERING EMISSIONS OF A POLYURETHANE FOAM

(75) Inventors: Peter HAAS, Haan (DE); Gundolf JACOBS, Rosrath (DE); Sven MEYER-AHRENS, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/487,137

(22) Filed: Jun. 18, 2009

(30) Foreign Application Priority Data
Jun. 28, 2008 (DE) 102008030763.7

(51) Int. Cl. C08J 9/12

(52) U.S. Cl. 521/128

(57) ABSTRACT

The present invention provides a process for producing polyurethane foams from (A1) compounds with a molecular weight of 400-15,000 exhibiting hydrogen atoms that are reactive towards isocyanates, (A2) optionally, compounds with a molecular weight of 62-399 exhibiting hydrogen atoms that are reactive towards isocyanates, (A3) water and/or physical blowing agents, (A4) optionally, auxiliary substances and additives, (A5) compounds with at least one carbonamide group and one nitrile group, and (B) diisocyanates or polyisocyanates, which results in polyurethane foams with lowered emission of formaldehyde and wherein the activity of the raw-material mixture is not significantly influenced and wherein the mechanical properties of the resulting foam (in particular, compression set and ageing behaviour under humid conditions) are not influenced negatively.

### RELATED APPLICATIONS

This application claims benefit to German Patent Application No. 10 2008 030 763.7, filed Jun. 28, 2008, which is incorporated herein by reference in its entirety for all useful purposes.

### BACKGROUND OF THE INVENTION

It is known from the state of the art that polyurethane foams may emit formaldehyde, this emission of formaldehyde being generally undesirable. These emissions are detected, for example, in the course of measurements in accordance with VDA 275 (bottle method, 3 h 60° C.) or even in accordance with VDA 276 (emission-chamber test, 65° C.). These formaldehyde emissions may arise already in freshly produced foams and may be intensified by ageing processes, especially photo-oxidation.

In EP-A 1 428 847 a process is described for lowering emissions of formaldehyde from polyurethane foams by addition of polymers exhibiting amino groups. Thus as a result of addition of polyvinyl amines the formaldehyde content according to VDA 275 is brought down to below the detection limit of 0.1 ppm. A disadvantageous aspect of such functional—in particular, amino-functional—additives can be the influence thereof on the activity of the raw-material mixture. Properties such as the flow behaviour or even the open-cell character are often affected as a result.

The object of the present invention was therefore to develop a process for producing polyurethane foams that results in polyurethane foams with lowered emission of formaldehyde and wherein the activity of the raw-material mixture is not influenced significantly and wherein the mechanical properties of the resulting foam (in particular, compression set and ageing behaviour under humid conditions) are not influenced negatively. In a further embodiment of the invention, the resulting foams are furthermore to exhibit a low migration-and-emission behaviour with respect to the activators and additives employed.

It has now surprisingly been found that the aforementioned technical object is achieved by means of a production process in which compounds with at least one carbonamide group and one nitrile group are employed.

### EMBODIMENTS OF THE MENTION

An embodiment of the present invention is a process for producing polyurethane foams with lowered emission of formaldehyde comprising reacting
A1 compounds having a molecular weight in the range of from 400 to 15,000 and which contain hydrogen atoms that are reactive towards isocyanates;
A2 optionally, compounds having a molecular weight in the range of from 62 to 399 and which contain hydrogen atoms that are reactive towards isocyanates;
A3 water and/or physical blowing agents;
A4 optionally, auxiliary substances and additives;
A5 compounds which contain at least one carbonamide group and one nitrile group; and
B diisocyanates or polyisocyanates.

Another embodiment of the present invention is the above process, wherein from 0.1 to 10 parts by weight of A5, relative to 100 parts by weight of components A1, A2, A3, and A4, is used.

Another embodiment of the present invention is the above process, wherein, relative to the sum of the parts by weight of components A1 to A4, A1 is present in the amount of from 75 to 99.5 parts by weight; A2 is present in the amount of from 0 to 10 parts by weight; A3 is present in the amount of from 0.5 to 25 parts by weight; A4 is present in the amount of from 0 to 10 parts by weight; and A5 is present in the amount of from 0.1 to 10 parts by weight; and wherein production takes place with an index from 50 to 250.

Another embodiment of the present invention is the above process, wherein A4 comprises
a) a catalyst;
b) a surface-active additive; and
c) an additive selected from the group consisting of reaction-retarders, cell-regulators, pigments, dyestuffs, flameproofing agents, stabilisers for countering effects of ageing and weathering, plasticisers, substances acting fungistatically and bacteriostatically, fillers, and release agents, and mixtures thereof.

Another embodiment of the present invention is the above process, wherein said catalyst comprises
a) urea, derivatives of urea; and/or
b) aliphatic tertiary amines, cycloaliphatic tertiary amines, aliphatic amino ethers, and/or cycloaliphatic amino ethers, wherein said amines and amino ethers contain a functional group that reacts chemically with said isocyanate.

Another embodiment of the present invention is the above process, wherein A5 comprises at least one compound according to formulae (I) (II), (III), and (IV)

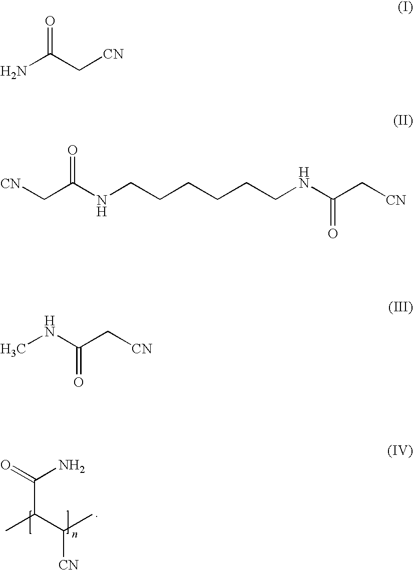

### DESCRIPTION OF THE INVENTION

The present invention provides a process for producing polyurethane foams with lowered emission of formaldehyde from
A1 compounds with a molecular weight of 400-15,000 exhibiting hydrogen atoms that are reactive towards isocyanates,
A2 optionally, compounds with a molecular weight of 62-399 exhibiting hydrogen atoms that are reactive towards isocyanates,
A3 water and/or physical blowing agents,
A4 optionally, auxiliary substances and additives such as
   a) catalysts,
   b) surface-active additives,
   c) pigments or flameproofing agents,
A5 compounds with at least one carbonamide group and one nitrile group, and
B diisocyanates or polyisocyanates.

The quantity employed of component A5 according to the invention, relative to 100 parts by weight of components A1 to A4, amounts to 0.1-10 parts by weight preferably 0.2-5 parts by weight.

The present invention provides, in particular, a process for producing polyurethane foams with lowered emission of formaldehyde from

Component A:
A1 75 to 99.5 parts by weight preferably 89 to 97.7 parts by weight (relative to the sum of the parts by weight of components A1 to A4), of compounds with a molecular weight of 400-15,000 exhibiting hydrogen atoms that are reactive towards isocyanates,
A2 0 to 10 parts by weight, preferably 0.1 to 2 parts by weight (relative to the sum of the parts by weight of components A1 to A4), of compounds with a molecular weight of 62-399 exhibiting hydrogen atoms that are reactive towards isocyanates,
A3 0.5 to 25 parts by weight, preferably 2 to 5 parts by weight (relative to the sum of the parts by weight of components A1 to A4), of water and/or physical blowing agents,
A4 0 to 10 parts by weight, preferably 0.2 to 4 parts by weight (relative to the sum of the parts by weight of components A1 to A4), of auxiliary substances and additives such as
   a) catalysts,
   b) surface-active additives,
   c) pigments or flameproofing agents,
A5 0.1-10 parts by weight preferably 0.2-5 parts by weight (relative to the sum of the parts by weight of components A1 to A4), of compounds with at least one carbonamide group and one nitrile group, and

Component B:
B diisocyanates or polyisocyanates,

wherein production takes place with an index from 50 to 250, preferably 70 to 130, particularly preferably 75 to 115, and

wherein all the parts-by-weight data of components A1 to A4 in the present application have been normalised in such a way that the sum of the parts by weight of components A1+A2+A3+A4 in the composition yields 100.

It has been found that compounds with at least one carbonamide group and one nitrile group (component A5) surprisingly act as formaldehyde-catchers. The invention therefore further provides the use of the compounds with at least one carbonamide group and one nitrile group (component A5) in polyurethane compositions or in processes for producing polyurethane foams for the purpose of lowering the emission of formaldehyde.

The production of foams on the basis of isocyanate is known as such and described, for example, in DE-A 1 694 142, DE-A 1 694 215 and DE-A 1 720 768 and also in the Kunststoff-Handbuch Volume VII, Polyurethane, edited by Vieweg und Höjchtlein, Carl Hanser Verlag Munich 1966, and also in the new edition of this book, edited by G. Oertel, Carl Hanser Verlag Munich, Vienna 1993.

In this connection it is predominantly a question of foams exhibiting urethane groups and/or uretdione groups and/or urea groups and/or carbodiimide groups. The use according to the invention preferentially takes place in connection with the production of polyurethane foams and polyisocyanurate foams.

For the production of the foams on the basis of isocyanate, the components described in more detail in the following may be employed.

Component A1

Initial components according to component A1 are compounds with at least two hydrogen atoms that are reactive towards isocyanates, with a molecular weight, as a rule, of 400-15,000. These are understood to be—in addition to compounds exhibiting amino groups, thio groups or carboxyl groups—preferentially compounds exhibiting hydroxyl groups, in particular compounds exhibiting 2 to 8 hydroxyl groups, especially those of molecular weight 1000 to 6000, preferentially 2000 to 6000, for example polyethers and polyesters exhibiting at least 2, as a rule 2 to 8, but preferentially 2 to 6, hydroxyl groups, and also polycarbonates and polyester amides, as known as such for the production of homogeneous polyurethanes and of cellular polyurethanes, and as described, for example, in EP-A 0 007 502, pages 8-15. The polyethers exhibiting at least two hydroxyl groups are preferred in accordance with the invention.

Component A2

Compounds with at least two hydrogen atoms that are reactive towards isocyanates and with a molecular weight from 32 to 399 are optionally employed as component A2. These are understood to include compounds exhibiting hydroxyl groups and/or amino groups and/or thiol groups and/or carboxyl groups, preferentially compounds exhibiting hydroxyl groups and/or amino groups that serve as chain-extending agents or crosslinking agents. These compounds exhibit, as a rule, 2 to 8, preferentially 2 to 4, hydrogen atoms that are reactive towards isocyanates. For example, ethanolamine, diethanolamine, triethanolamine, sorbitol and/or glycerin may be employed as component A2. Further examples of compounds according to component A2 are described in EP-A 0 007 502, pages 16-17.

Component A3

Water and/or physical blowing agents are employed as component A3. By way of physical blowing agents, carbon dioxide and/or readily volatile organic substances, for example, are employed as blowing agents.

Component A4

By way of component A4, use is optionally made of auxiliary substances and additives such as
a) catalysts (activators),
b) surface-active additives (surfactants) such as emulsifiers and foam stabilisers, in particular those with low emission, such as, for example, products from the Tegostab® LF series,
c) additives such as reaction-retarders (for example, substances reacting acidically, such as hydrochloric acid or organic acid halides), cell-regulators (such as, for example, paraffins or fatty alcohols or dimethyl polysiloxanes), pigments, dyestuffs, flameproofing agents (such as, for example, tricresyl phosphate), stabilisers for countering effects of ageing and weathering, plasticisers, substances acting fungistatically and bacteriostatically, fillers (such as, for example, barium sulfate, diatomaceous earth, black chalk or precipitated chalk) and release agents.

These auxiliary substances and additives to be optionally used concomitantly are described, for example, in EP-A 0 000 389, pages 18-21. Further examples of auxiliary substances and additives optionally to be used concomitantly in accordance with the invention and also details about the manner of use and mode of action of these auxiliary substances and additives are described in the Kunststoff-Handbuch, Volume VII, edited by G. Oertel, Carl-Hanser-Verlag, Munich, 3rd Edition, 1993, for example on pages 104-127.

By way of catalysts, aliphatic tertiary amines (for example, trimethylamine, tetramethylbutanediamine), cycloaliphatic tertiary amines (for example, 1,4-diaza(2,2,2)bicyclooctane), aliphatic amino ethers (for example, dimethylaminoethyl ether and N,N,N-trimethyl-N-hydroxyethyl-bisaminoethyl ether), cycloaliphatic amino ethers (for example, N-ethylmorpholine), aliphatic amidines, cycloaliphatic amidines, urea, derivatives of urea (such as, for example, aminoalkyl ureas, see, for example, EP-A 0 176 013, in particular (3-dimethylaminopropylamine)urea) and tin catalysts (such as, for example, dibutyltin oxide, dibutyltin dilaurate, tin octoate) are preferred.

As catalysts are particularly preferred:

a) urea, derivatives of urea and/or

b) amines and amino ethers, characterised in that the amines and amino ethers contain a functional group that reacts chemically with the isocyanate. The functional group is preferentially a hydroxyl group, a primary or secondary amino group. These particularly preferred catalysts have the advantage that they exhibit a greatly reduced migration-and-emission behaviour.

As examples of particularly preferred catalysts, the following may be mentioned: (3-dimethylaminopropylamine)urea, 2-(2-dimethylaminoethoxy)ethanol, N,N-bis(3-dimethylaminopropyl)-N-isopropanolamine, N,N,N-trimethyl-N-hydroxyethyl-bisaminoethyl ether and 3-dimethylaminopropylamine.

Component A5

By way of compounds with at least one carbonamide group and one nitrile group (component A5), the compounds according to formulae (I) to (IV) may be cited in exemplary manner.

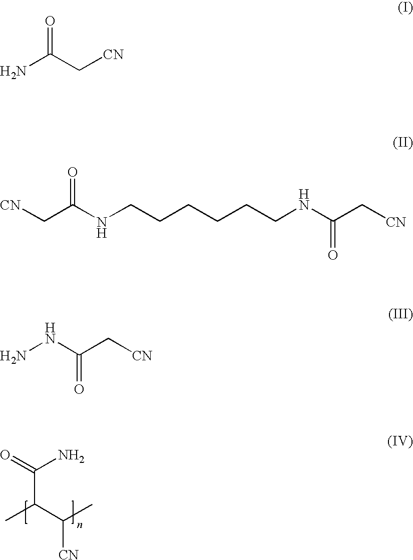

Component B

By way of component B, aliphatic, cycloaliphatic, araliphatic, aromatic and heterocyclic polyisocyanates are employed, such as are described, for example, by W. Siefken in Justus Liebigs Annalen der Chemie, 562, pages 75 to 136, for example those of the formula (V)

Q(NCO)ₙ (V)

in which

n=2−4, preferentially 2−3,

and

Q signifies an aliphatic hydrocarbon residue with 2-18, preferentially 6-10, C atoms, a cycloaliphatic hydrocarbon residue with 4-15, preferentially 6-13, C atoms or an araliphatic hydrocarbon residue with 8-15, preferentially 8-13, C atoms.

For example, it is a question of polyisocyanates such as are described in EP-A 0 007 502, pages 7-8. Particularly preferred are, as a rule, the technically easily accessible polyisocyanates, for example 2,4- and 2,6-toluylene diisocyanate, and also arbitrary mixtures of these isomers (‘TDI’); polyphenyl polymethylene polyisocyanates such as are produced by aniline/formaldehyde condensation and subsequent phosgenation (‘crude MDI’) and polyisocyanates exhibiting carbodiimide groups, urethane groups, allophanate groups, isocyanurate groups, urea groups or biuret groups (‘modified polyisocyanates’), in particular those modified polyisocyanates which are derived from 2,4- and/or 2,6-toluylene diisocyanate or from 4,4′- and/or 2,4′-diphenylmethane diisocyanate. Preferentially at least one compound selected from the group consisting of 2,4- and 2,6-toluylene diisocyanate, 4,4′- and 2,4′- and 2,2′-diphenylmethane diisocyanate and polyphenyl polymethylene polyisocyanate (‘polynuclear MDI’) is/are employed as component B.

Implementation of the Process for Producing Polyurethane Foams:

The reaction components are caused to react in accordance with the single-stage process known as such, in accordance with the prepolymer process or in accordance with the semiprepolymer process, in which connection use is often made of mechanical devices, for example those which are described in EP-A 355 000. Details concerning processing devices that also enter into consideration in accordance with the invention are described in the Kunststoff-Handbuch, Volume VII, edited by Vieweg and Höchtlen, Carl-Hanser-Verlag, Munich 1993, for example on pages 139 to 265.

The PUR foams cam be produced as moulded foams or even as slabstock foams.

The moulded foams can be produced in hot-curing manner or even in cold-curing manner.

The invention therefore provides a process for producing the polyurethane foams, the polyurethane foams produced in accordance with this process, and the use thereof for the purpose of producing mouldings, and also the mouldings themselves.

The polyurethane foams that can be obtained in accordance with the invention find the following use, for example: furniture upholsteries, textile inserts, mattresses, car seats, head supports, arm rests, sponges and structural elements, as well as seat linings and instrument panellings.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

Description of the Raw Materials

Component A-1-1:

Polyether polyol with hydroxyl value 28, produced by addition of propylene oxide and ethylene oxide in a ratio of 86.2 to 13.8 % using glycerin as starter with at least 80% primary OH groups.

Component A1-2:

Polyether polyol with hydroxyl value 37, produced by addition of ethylene oxide and propylene oxide in a ratio of 72.5% to 27.5% using glycerin as starter with at least 80% primary OH groups.

Component A2-1: Diethanolamine

Component A3-1: Water

Component A4:

Component A4-1:

Stabiliser Tegostab® B 8734 LF (Degussa-Goldschmidt).

Component A4-2:

Activator Jeffcat® ZR 50, (Huntsman); an amine containing a functional group that reacts chemically with the isocyanate.

Component A4-3:

Activator Dabco® NE 300 (Air Products); contains a urea derivative.

Component A5-1:

Cyanoacetic acid amide

Component B-1:

Isocyanate mixture (from the MDI series) containing 57 wt. % 4,4′-diphenylmethane diisocyanate, 25 wt. % 2,4′-diphenylmethane diisocyanate and 18 wt. % polyphenyl polymethylene polyisocyanate (‘polynuclear MDI’).

Production of the Mouldings

Under the conditions for processing the raw-material mixture that are conventional for the production of PUR foams at room temperature via a high-pressure mixing head, in accordance with the constitution of the formulation the initial components are introduced into a mould with a volume of 12.5 L heated to 60° C. and are removed from the mould after 4 min. The quantity of the raw materials employed was chosen in such a way that a calculated moulding density of 55 kg/m³ results. Specified in Table 1 is the moulding density actually obtained, which was determined by weighing the compressive-strength test piece.

The index (isocyanate index) specifies the percentage ratio of the isocyanate quantity actually employed to the stoichiometric—i.e. calculated—quantity of isocyanate groups (NCO):

Index=[(isocyanate quantity employed): (isocyanate quantity calculated)]·100 (VI)

The compressive strength was determined in accordance with DIN EN ISO 3386-1-98.

The compression sets CS 50% and CS 75% were determined in accordance with DIN EN ISO 1856-2001-03 at 50% and 75% deformation, respectively.

The formaldehyde content was carried out following the model of BMW method AA-C291, whereby, departing from this method, (a) angular glass bottles were employed instead of round polyethylene bottles, (b) the test piece that was used exhibited a thickness of 1 cm (instead of 4 mm), (c) a calibration standard produced by Cerilliant was employed, and (d) the moisture content of the sample was not ascertained.

The compression set at 70% deformation after storage in humid and warm conditions (HWS), i.e. 22 hours at 40° C. and 95% rel. humidity (CS 70% after HWS) was determined in accordance with DIN EN ISO 1856-2001-03.

TABLE 1
Compositions and properties of the resulting mouldings

| Components | 1 | | 3 |
|---|---|---|---|
| [parts by weight] | (Comparison) | 2 | (Comparison) |
| A. Polyol formulation | | | |
| A1-1 | 97.0 | 97.0 | 97.0 |
| A1-2 | 3.0 | 3.0 | 3.0 |
| A2-1 (Diethanolamine) | 1.2 | 1.2 | 1.2 |
| A3-1 (Water) | 3.5 | 3.5 | 3.5 |
| A4-1 | 0.9 | 0.9 | 0.9 |
| A4-2 | 0.4 | 0.4 | 0.4 |
| A4-3 | 0.1 | 0.1 | 0.1 |
| A5-1 | — | 1.0 | 30 |
| B. Isocyanate | | | |
| B-1 relative to 100 parts by | 55.0 | 54.5 | 39.25 |
| weight polyol formulation | | | |
| [parts by weight] | | | |
| Index | 95 | 95 | 95 |
| Properties | | | |
| Bulk density [kg/m³] | 55.0 | 55.0 | 59.5 |
| Emission of formaldehyde | 2.4 | <0.1 | n.m. |
| on the basis of BMW test | | | |
| according to | | | |
| AA-C291 [ppm] | | | |
| Compressive strength [kPa] | 9.5 | 9.5 | 9.4 |
| CS 50% [%] | 7.4 | 6.3 | 17.7 |
| CS 75% [%] | 8.6 | 7.9 | 31.0 |
| CS 70% after HWS [%] | 17.3 | 16.1 | 28.6 |

n.m. = not measured

The value in respect of emission of formaldehyde ascertained on the basis of BMW test for determining the emission of aldehydes from polymeric materials and mouldings by means of HPLC AA-C29 1 is lowered by the compound according to the invention as per Example 2 to below the detection limit of 0.1 ppm, whereas the Comparative Example 1 exhibits an emission of formaldehyde of 2.4 ppm.

Although cyanoacetic acid amide is named in EP-A 0 358 021 as a flameproofing agent in addition to oxalic acid amide and hydrazodicarbonamide, of these compounds only cyanoacetic acid amide is effective as formaldehyde-catcher. In comparison with EP-A 0 358 021 (in this regard see Comparative Example 3), the quantity employed in accordance with the present invention can be distinctly reduced, see Example 2. Indications of the effectiveness, which has now been found, of cyanoacetic acid amide as formaldehyde-catcher is neither disclosed nor suggested in EP-A 0 358 021. The lower quantity of cyanoacetic acid amide employed has an advantageous effect, in particular, on the ageing of the foam under humid conditions.

Comparative Example 3 differs from the composition according to Example 2 merely in the quantity of cyanoacetic acid amide (30 parts by weight instead of 1 part by weight, relative to 100 parts by weight of components A1 to A4). The flexible foam correspondingly resulting according to Comparative Example 3 exhibits a lower level of mechanical properties overall: in contrast, Example 2 according to the invention (containing 1 part by weight cyanoacetic acid amide relative to 100 parts by weight of components A1 to A4) exhibits a diminution of the emission of formaldehyde to below the detection limit of 0.1 ppm and an almost unchanged compression-set behaviour and ageing behaviour under humid conditions relative to Comparative Example 1 (without cyanoacetic acid amide).

1. A process for producing polyurethane foams with lowered emission of formaldehyde comprising reacting
A1 compounds having a molecular weight in the range of from 400 to 15,000 and which contain hydrogen atoms that are reactive towards isocyanates;
A2 optionally, compounds having a molecular weight in the range of from 62 to 399 and which contain hydrogen atoms that are reactive towards isocyanates;
A3 water and/or physical blowing agents;
A4 optionally, auxiliary substances and additives;
A5 compounds which contain at least one carbonamide group and one nitrile group; and
B diisocyanates or polyisocyanates.

2. The process of claim 1, wherein from 0.1 to 10 parts by weight of A5, relative to 100 parts by weight of components A1, A2, A3, and A4; is used.

3. The process of claim 1, wherein, relative to the sum of the parts by weight of components A1 to A4, A1 is present in the amount of from 75 to 99.5 parts by weight; A2 is present in the amount of from 0 to 10 parts by weight; A3 is present in the amount of from 0.5 to 25 parts by weight; A4 is present in the amount of from 0 to 10 parts by weight; and A5 is present in the amount of from 0.1 to 10 parts by weight; and wherein production takes place with an index from 50 to 250.

4. The process of claim 1, wherein A4 comprises
a) a catalyst;
b) a surface-active additive; and
c) an additive selected from the group consisting of reaction-retarders, cell-regulators, pigments, dyestuffs, flameproofing agents, stabilisers for countering effects of ageing and weathering, plasticisers, substances acting fungistatically and bacteriostatically, fillers, and release agents, and mixtures thereof.

5. The process of claim 4, wherein said catalyst comprises
a) urea, derivatives of urea; and/or
b) aliphatic tertiary amines, cycloaliphatic tertiary amines, aliphatic amino ethers, and/or cycloaliphatic amino ethers, wherein said amines and amino ethers contain a functional group that reacts chemically with said isocyanate.

6. The process of claim 1, wherein A5 comprises at least one compound according to formulae (I), (II), (III), and (IV) [chemical structure]
